(19) United States
(12) Patent Application Publication
(10) Pub. No.: US 2002/0152058 A1
(43) Pub. Date: Oct. 17, 2002

(54) System for simulating a contactless data communication between a read/write station and at least one data carrier

(76) Inventors: Andreas Muehlberger, Graz (AT); Wolfgang Meindl, Graz (AT); Hauke Meyn, Krempermoor (DE)

Correspondence Address: U.S. Philips Corporation, 580 White Plains Road, Tarrytown, NY, 10591, US

(21) Appl. No.: 10/083,459

(22) Filed: Oct. 22, 2001

(30) Foreign Application Priority Data
Oct. 23, 2000 (EP) 00890320.5

(51) Int. Cl. G06G 7/62; G06F 17/50

(52) U.S. Cl. 703/13

(57) ABSTRACT

A system (1) for simulating a data communication between a read/write station and a portable data carrier comprises representation means for presenting a read/write station while the representation means are formed by station simulation means (2) for simulating the behavior of a read/write station arranged for a contactless data communication, which system (1) further includes data carrier simulation means (4) for simulating the behavior of a data carrier, while the data carrier simulation means (4) are arranged for simulating the behavior of a data carrier arranged for a contactless data communication, and which system (1) further includes transmission means (6) for transmitting data (D) between the station simulation means (2) and the data carrier simulation means (4).

The invention relates to a system for simulating a data communication between a read/write station and a portable data carrier, which system comprises representation means representing a read/write station, and data carrier simulation means for simulating the behavior of a data carrier, and transmission means for transmitting data between the representation means and the data carrier simulation means.

The invention further relates to a system part which is provided for simulating the behavior of a read/write station arranged for communication with a portable data carrier and which part includes representation means representing a read/write station.

The invention further relates to a system part which is provided for simulating the behavior of a portable data carrier arranged for communication with a read/write station and which part includes data carrier simulation means which are arranged for simulating the behavior of a data carrier.

The invention further relates to a method of simulating a data communication between a read/write station and a portable data carrier, which method includes the following steps, that is:

Activating transmission means provided for transmitting data between representation means and data carrier simulation means, in which the representation means represent the read/write station and the data carrier simulation means are provided for simulating the behavior of the data carrier, and

Communicating data with the aid of the activated transmission means between the representation means and the data carrier simulation means.

A system as defined in the opening paragraph and a system part as defined in the second paragraph and a system part of the type defined in the third paragraph and a method as defined in the fourth paragraph have been marketed by the applicants and are therefore known. In the known system the representation means representing a read/write station are formed by an actually realized read/write station which is arranged for contact-bound communication. A so-called RS232 link is connected to the actually provided read/write station as transmission means. A personal computer with the aid of which the data carrier simulation means are realized is connected to the RS232 link, which data carrier simulation means are arranged in the known system only for simulating the behavior of a contact-bound data carrier. A really built read/write station is to be available in the known system for development and test purposes, which stands for considerable financial expenditure. Furthermore, there is a problem in the known system that only a simulation of a contact-bound data communication between the read/write station and only a single data carrier can be effected.

It is an object of the invention with a system according to an embodiment described in the first paragraph and with a system part of the second paragraph and a system part of the third paragraph and with a method of the type defined in the fourth paragraph to eliminate the problems defined above and provide an improved system and improved system parts and an improved method.

To achieve the object described above, a system in accordance with the embodiment set forth in the first paragraph is provided according to the invention in that the representation means are formed by station simulation means and in that the station simulation means are provided for simulating the behavior of a read/write station arranged for a contactless data communication and in that the data carrier simulation means are arranged for simulating the behavior of a data carrier arranged for a contactless data communication.

To achieve the object described above, a system part in accordance with the embodiment set forth in the second paragraph is provided according to the invention in that the representation means are formed by station simulation means and in that the station simulation means are arranged for simulating the behavior of a read/write station arranged for a contactless data communication.

To achieve the object described above, a system part in accordance with the embodiment set forth in the third paragraph is provided according to the invention in that the data carrier simulation means are arranged for simulating the behavior of a data carrier arranged for a contactless data communication.

To achieve the object described above, a method in accordance with the embodiment set forth in the fourth paragraph is provided according to the invention in that with the aid of station simulation means arranged as representation means the behavior of a read/write station arranged for a contactless data communication is simulated and in that with the aid of data carrier simulation means arranged for this purpose the behavior of a data carrier arranged for a contactless data communication is simulated and in that a contactless communication of data between the station simulation means and the data carrier simulation means is simulated.

By providing the measures according to the invention there is achieved that no actually realized read/write station is necessary for contactless communication for simulation purposes in the course of development and test processes, which entails considerable saving of cost. Furthermore, by providing the measures according to the invention there is achieved that with the aid of the station simulation means and the data carrier simulation means also a contactless data communication can be simulated between a read/write station arranged for a contactless data communication and at least one data carrier arranged for a contactless data communication. Furthermore, the advantage is obtained that with the aid of the station simulation means it is very simple to adapt a plurality of station parameters to respective requirements.

With the system according to the invention it has proved to be particularly advantageous when a plurality of data carrier simulation means are provided. This provides the great advantage that at the same time a plurality of simulation processes of data communications between the station simulation means and the plurality of data carrier simulation means can be effected, so that the situations and problems occurring in practice when contactless-communication data carriers are used can be simulated in an effective and easy manner.

With a system according to the invention it has further proved to be advantageous when the plurality of data carrier simulation means are divided over various locations. This offers the advantage that when operating conditions of data carriers arranged for contactless communication at various locations are simulated, so that, on the one hand, computing power necessary for the simulation is accordingly reduced per simulation and, on the other hand, an analysis of a simulation result undisturbed by other simulations is ensured.

With a system according to the invention it has proved to be advantageous when the plurality of data carrier simulation means are divided over various locations as regards station simulation means. This offers the advantage that when computer programs are developed for a read/write station and computer programs are developed for data carriers, the respective development can be performed at entirely different locations, so that optimum use of development resources is ensured.

With a system according to the invention, the transmission means may be realized with the aid of an RS232 link, as this is also the case with the known system. It has proved to be highly advantageous, however, when the transmission means are formed by means for realizing a data network. Compared to a real data communication between a read/write station and a data carrier, this offers the advantage that restrictions as regards a distance between the read/write station and the data carrier can be avoided via a data network.

In a system according to the invention it has further proved to be advantageous when the data network is arranged for communication in accordance with an Interprocess Communication protocol. This offers the advantage that an exchange of data, as this occurs in a data communication between a read/write station and a data carrier both with a contact-bound and with a contact less data communication, can from now on be simulated with the aid of a data network without any problem in a reliable manner.

In a system according to the invention the data network may be provided, for example, for communication in accordance with a Dynamic Data Exchange protocol, DDE protocol for short, or in accordance with an Object-Link-and-Embedding-protocol, OLE protocol for short. However, it has proved to be particularly advantageous when the data network is arranged for communication according to the TCP/IP protocol. This offers the advantage that the data network is arranged for communication in accordance with a de facto Industrial Standard protocol. This offers the advantage that the data network can be realized without any problem in a reliable manner both in a single computer and in an intranet. In this connection, however, it has further proved to be highly advantageous that also the internet can be used as a data network.

In a system according to the invention it has further proved to be advantageous when the station simulation means comprise station contactless interface simulation means which are arranged for simulating the behavior of a contactless interface of the station simulation means, and when the station simulation means have station connection means, which are arranged for connecting the station contactless interface simulation means to the transmission means. This offers the advantages that the behavior of an interface arranged for contactless communication can be entirely simulated and that, with the aid of the transmission means, when a contactless data transmission is simulated, data can actually be exchanged.

In a system according to the invention it has further proved to be advantageous when the station connection means are arranged for connecting the station-contactless interface simulation means to the transmission means in accordance with an Interprocess Communication protocol. This offers the advantage that when a contactless data communication is simulated, data can be exchanged bidirectionally in a reliable manner.

In a system according to the invention it has further proved to be advantageous when the station connection means are arranged for connecting the station-contactless interface simulation means to the transmission means in accordance with the TCP/IP protocol. This offers the advantage that when the connection is there, a de facto Industrial Standard protocol is used, which can be used without any problem and locally but also globally.

In a system according to the invention it has further proved to be advantageous when the data carrier simulation means comprise data carrier contactless interface simulation means, which are arranged for simulating the behavior of a contactless interface of the data carrier simulation means, and when the data carrier simulation means comprise data carrier connection means which are arranged for connecting the data carrier contactless interface simulation means to the transmission means. This offers advantages for the data carrier simulation means which are similar to the advantages of the station simulation means.

In a system according to the invention it has further proved to be advantageous when the data carrier connection means are arranged for connecting the data carrier contactless interface simulation means to the transmission means in accordance with an Interprocess Communication protocol. This offers an advantage for the data carrier connection means which is similar to the advantage of the station connection means.

In a system according to the invention it has further proved to be advantageous when the data carrier connection means are arranged for connecting the data carrier contactless interface simulation means to the transmission means in accordance with the TCP/IP protocol. This offers an advantage to the data carrier connection means, which advantage is similar to that of the station connection means.

The aspects defined above and further aspects of the invention will be apparent from the examples of embodiment described hereinafter and will be explained with reference to these examples of embodiment.

These and other aspects of the invention are apparent from and will be elucidated with reference to the embodiments described hereinafter.

In the drawings:

FIG. 1 shows in a highly diagrammatic manner in the form of a block diagram a system according to a first example of embodiment of the invention,

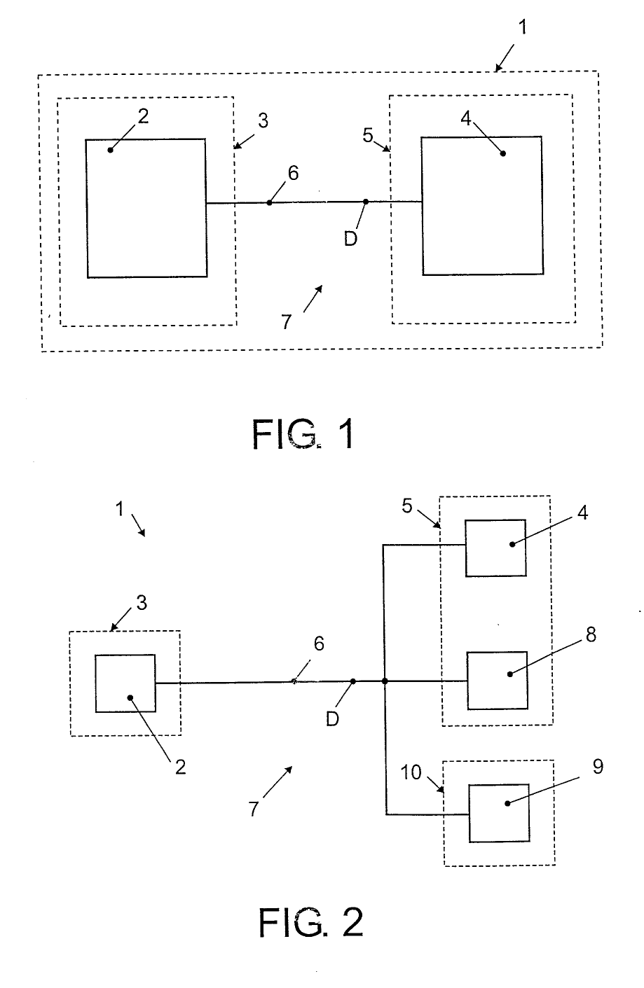

FIG. 2 shows in similar manner to FIG. 1 a system according to a second example of embodiment of the invention, and

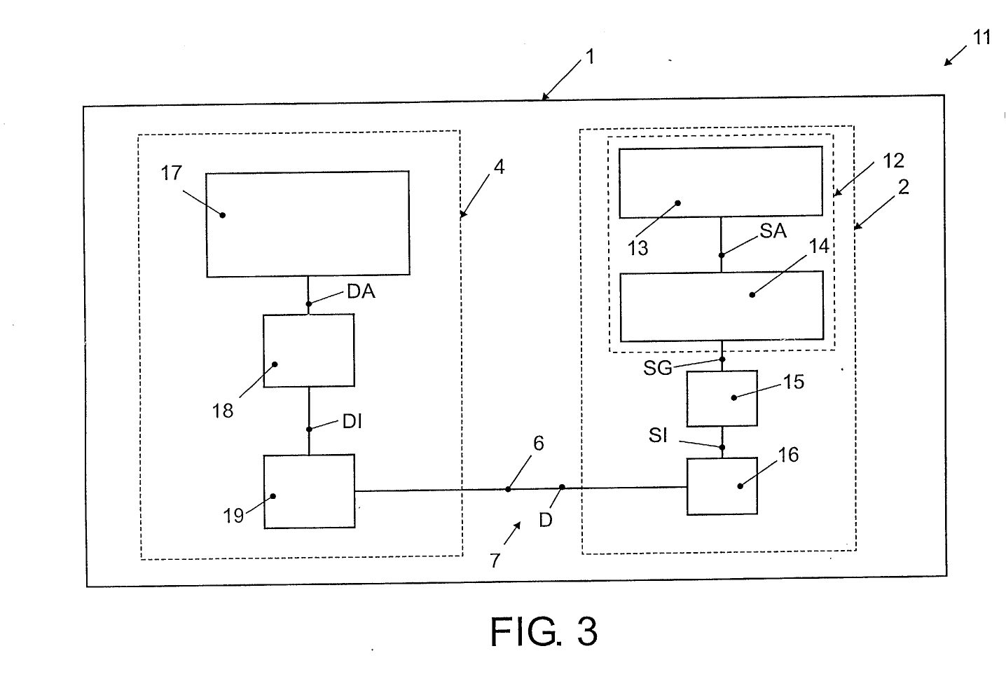

FIG. 3 shows in a detailed manner relative to FIG. 1 a system according to a third example of embodiment of the invention.

FIG. 1 shows a system 1 which is arranged for simulating a data communication between a read/write station arranged for contactless data communication and a portable data carrier also arranged for contactless data communication.

The system 1 comprises, which is new and advantageous, station simulation means 2 which form representation means for representing the read/write station. The station simulation means 2 are here arranged for simulating the behavior of a read/write station arranged for a contactless data communication, which is also new and advantageous, and are realized with the aid of a first computer 3 and software that can be executed on the first computer 3.

The system 1 further includes data carrier simulation means 4 which are arranged for simulating the behavior of a data carrier arranged for a contactless data communication and which are realized by a second computer 5 on which respective software can be executed.

The system 1 further includes transmission means 6 which are connected between the station simulation means 2 and the data carrier simulation means 4 and which are arranged for transmitting data between the station simulation means 2 forming the representation means and the data carrier simulation means 4. The transmission means 6 are formed with the aid of means for realizing a data network 7. The data network 7 is formed by hardware components not shown in FIG. 1 of the first computer 3 and of the second computer 5 and by suitable software components for operating these hardware components and with the aid of a hardware network connection between the first computer 3 and the second computer 5. A respective identification number, that is, an IP address, is assigned to the first computer 3 and to the second computer 5. In the present case the first computer 3 is arranged for storing the IP address of the second computer 5. The hardware components are formed by network connections and network cards. The hardware network connection is realized by a network cable, so that data D can be exchanged between the station simulation means 2 and the data carrier simulation means 4. In this connection may be stated that the network connection can be realized by an infrared or radio link when hardware components cooperate with respective software components. Furthermore it may be stated that the data network 7 may also have computers of its own with respective software and which are provided for routing the data.

For exchanging or transmitting the data D, the data network 7 is arranged for communication in accordance with an Interprocess Communication protocol, in which the data network 7 is advantageously provided for communicating in accordance with a de facto Industrial Standard protocol, that is TCP/IP protocol.

In the following is explained with reference to a method of simulating a data communication between a read/write station and a portable data carrier, the mode of operation of the system 1 according to the first example of embodiment of the invention.

According to this method, first the software provided for station simulation means 2 is started on the first computer 3 so that, with the aid of the station simulation means 2 provided as representation means, the behavior of a read/write station arranged for a contactless data communication is simulated. Furthermore, with this method the software provided for the data carrier simulation means 4 is started on the second computer 5, so that the data carrier simulation means 4 arranged for this purpose simulate the behavior of a data carrier arranged for a contactless data communication. Furthermore, in this method the transmission means 6 are activated. The software components, which are provided for driving the hardware components as a means for realizing the data network 7, are started on the first computer 3 and on the second computer 5. Subsequently, the station simulation means 2 and the data carrier simulation means 4 verify whether the data network 7 is actually activated. If transmission means 6 are activated, a contactless communication of data is simulated between the station simulation means 2 and the data carrier simulation means 4, so that—as this is customary in contactless communication—first the station simulation means 2 checks the existence of a data carrier simulated with the aid of the data carrier simulation means 4 and, after a successful check of the existence of the data carrier, a contactless communication of data D between the station simulation means 2 and the data carrier simulation means 4 is simulated. The TCP/IP protocol available via the data network 7 then replaces the inductive or capacitive coupling between the read/write station and the data carrier in case of a contactless communication of data between a read/write station and a data carrier, while the contactless communication of the data per se is performed as before—as a reality—according to the communication protocol ISO14443 or is simulated between the station simulation means 2 and the data carrier simulation means 4.

FIG. 2 shows a system 1 which includes a plurality of data carrier simulation means, that is, the first data carrier simulation means 4 and second data carrier simulation means 8 and third data carrier simulation means 9, which are each arranged for simulating the behavior of a data carrier arranged for a contactless data communication. The first data carrier simulation means 4 and the second data carrier simulation means 8 are realized with the aid of software that can be executed on the second computer 5. The third data carrier simulation means 9 are realized with the aid of software that can be executed on a third computer 10. The station simulation means 2 are realized with software that can be executed on the first computer 3. Each of the three computers 3, 5 and 10 is connected to transmission means 6 and forms part of an in this case star-shaped data network 7, which is arranged for communication according to an Interprocess Communication protocol, that is, TCB/IP protocol. To each of the three computers 3, 5 and 10 is assigned an identification number, that is, an IP address, so that each computer is guaranteed to be addressed unambiguously according to the TCB/IP protocol. The third computer 3 is arranged for storing the IP address of the second computer 5 and of the third computer 10. When a data communication is simulated between the station simulation means 2 and the three data carrier simulation means 4, 8 and 9, the station simulation means 2 are arranged for managing these IP addresses.

In the following the mode of operation of the system 1 according to the second example of embodiment of the invention is explained with the aid of a software development divided over various locations for the read/write station arranged for contactless communication and for various data carriers arranged for contactless communication.

The first data carrier simulation means 4 and the second data carrier simulation means 8 are divided over various locations relative to the third data carrier simulation means 9. Furthermore, the first data carrier simulation means 4 and the second data carrier simulation means 8 and the third data carrier simulation means 9 are divided over various locations relative to the position of the station simulation means 2. In the present case, for example the second computer 5 is set up at a first software firm and the third computer 10 at a second software firm, while the first software firm and the second software firm develop software for data carriers arranged for contactless communication. The first computer 3 is set up, for example, at a third software firm which develops software for a read/write station arranged for contactless communication. Thus, the behavior of a plurality of data carriers arranged for a contactless data communication is simulated with the aid of the plurality of the data carrier simulation means 2, 8 and 9 arranged for this purpose. Furthermore, both the behavior of the plurality of the data carriers arranged for the contactless communication and also the behavior of the read/write station arranged for the contactless communication is simulated at different positions. In the course of this development a contactless communication of data D is simulated between the station simulation means 2 and the plurality of data carrier simulation means 4, 8 and 9 arranged for the contactless communication is simulated. The communication of data D is further simulated in data carrier simulation means 4, 8 and 9 at different locations. Furthermore, a contactless communication of data D between the station simulation means 2 and the plurality of the data carrier simulation means 4, 8 and 9 divided over various positions relative to the location of the station simulation means 2.

This achieves an enormous enhancement of efficiency for the development and testing of software for the read/write station arranged for contactless communication and for the data carriers arranged for contactless communication, because each local software firm can develop and advantageously test in a highly cost-effective manner under optimal conditions the software to be programmed by it at its respective location with the aid of the simulated behavior of the read/write station or of the data carrier. Furthermore, the advantage is obtained that the simulation of a data communication between the simulated read/write station arranged for contactless communication and the in the example three portable simulated data carriers arranged for contactless communication can be simulated independently of the respective location of the software firm. This corresponds to the real situation where a plurality of data carriers are involved in the contactless communication in the read/write station whereas, in contrast to this real situation, the then necessary physical distances between the read/write station and the plurality of data carriers may be discarded. This further provides the advantage that when the data communication is simulated, at the same time the behavior of the data carrier arranged for contactless communication or the read/write station arranged for contactless communication can be simulated without additional software such as, for example, an emulator, which additional software is relatively expensive compared to the system 1.

FIG. 3 shows a system 1 which is realized with the aid of a single computer 17. The system 1 includes the station simulation means 2 and the data carrier simulation means 4 and the transmission means 6.

The transmission means 6 are formed by means for realizing the data network 7 while here these means for realizing the data network 7 are formed without the aid of network cards and without the aid of a network cable, thus only with the aid of software that can be executed on the computer 1.

The station simulation means 2 include station data processing simulation means 12 which are arranged for simulating station data processing means of a real read/write station. The station data processing simulation means 12 include application execution means 13 and data conversion means 14. The station simulation means 2 further include station contactless interface simulation means 15 and station connection means 16.

The application execution means 13 are arranged for simulating the behavior of a read/write station when application software suitable for this read/write station is executed. The application execution means 13 are further arranged for exchanging station application data SA with the data conversion means 14. The application execution means 13 are formed by software that can be executed by the computer 11, which software allows of a simulation of a logic system of a real read/write station and a simulation of the behavior of this logic system when application software is processed, while the logic system in the present case represents a microprocessor. However, it may be observed that the logic system may also be formed by a hard-wired circuit.

The data conversion means 14 are arranged for simulating the behavior of a read/write station when station application data SA are changed into station generic data SG, or the other way around. The data conversion means 14 are further arranged for exchanging station application data SA with the application execution means 13 and for exchanging station generic data SG with the station contactless interface simulation means 15. The data conversion means 14 are formed in the present case with the aid of a dynamic link library, which is denoted as a Generic Low-Level Library in technical parlance, and which can be accessed when the application software is executed.

The station data processing simulation means 12 are also realized by software that can be executed on the computer 11 and are arranged for simulating the behavior of the logic system—as far as this is necessary—for simulating the behavior of storage means of the logic system or of storage means of the real read/write station and for simulating the behavior of interfaces or input/output devices of the read/write station.

The station contactless interface simulation means 15 are arranged for simulating the behavior of a contactless interface of the station simulation means 2. In this connection the station contactless interface simulation means 15 are arranged for receiving the Station Generic data SG and for converting the Station Generic data SG into Station Interface data SI and for delivering the Station Interface data SI to the station connection means 16. The station contactless interface simulation means 15 are further arranged for receiving the Station Interface data SI from the station connection means 16 and for converting the Station Interface data SI into Station Generic data SG and for delivering the Station Generic data SG to the data conversion means 14. The station contactless interface simulation means 15 are arranged by a software driver for simulating the electric circuit or the behavior of the circuit of a read/write station interface arranged for contactless communication. Furthermore, the station contactless interface simulation means 15 are arranged for managing the IP addresses necessary for the communication according to the TCP/IP protocol.

The station connection means 16 are arranged for connecting the station contactless interface simulation means 15 to the transmission means 16 while the connection is effected in accordance with the Interprocess Communication protocol, that is, in accordance with the TCP/IP protocol. On connection, the station connection means 16 are arranged for receiving the Station Interface data SI and for converting the Station Interface data SI into data D which can be transmitted via the TCP/IP protocol and for delivering the data D to the transmission means 6. Furthermore, the station connection means 16 are arranged, on connection, for receiving for the data D and for converting the data D into the Station Interface data SI.

The data carrier simulation means 4 include data carrier data processing simulation means 17 and data carrier contactless interface simulation means 18 and data carrier connection means 19.

The data carrier data processing simulation means 17 are formed by software that can be executed on the computer 11 and are arranged for simulating data processing means of a data carrier arranged for contactless communication and for simulating a behavior of these data processing means. In the present case the data processing means are formed by a microprocessor and include additional storage means. However, it may be observed that instead of the microprocessor also a hard-wired logic circuit may be used.

The data carrier connection means 18 are arranged for connecting the data carrier contactless interface simulation means 18 to the transmission means 6, that is, for connecting according to an Interprocess Communication protocol, that is, according to the TCP/IP protocol. The data carrier connection means 19 are further arranged for exchanging Data carrier Interface data DI with the data carrier contactless interface simulation means 18. With this exchange the data carrier connection means 19 are arranged for converting the Data carrier Interface data DI into the data D and for delivering the data D to the transmission means 6. With this exchange, the data carrier connection means 19 are further arranged for converting the received data D into the Data carrier Interface data DI and for delivering the Data carrier Interface data DI.

The data carrier contactless interface simulation means 18 are arranged for simulating the behavior of a contactless interface of the data carrier simulation means 4. In this connection, the data carrier contactless interface simulation means 18 are arranged, on the one hand, for receiving the Data carrier Interface data DI and for delivering Data carrier Application data DA, which can be generated by them from the Data carrier Interface data DI, to the data carrier data processing simulation means 17 and, on the other hand, for receiving the Data carrier Application data DA from the data carrier data processing simulation means 16 and for converting the received Data carrier Application data DA into the Data carrier Interface data DI and for delivering the Data carrier Interface DI.

In the following the mode of operation of the system 1 according to the third example of embodiment of the invention is explained by means of the simulation of the communication of the data D in the system 1.

When the communication of the data D from the station simulation means 2 to the data carrier simulation means 4 is simulated, the Station Application data SA contain application communication instructions with the aid of which application information can be sent in the form of data D from a simulated read/write station to a simulated data carrier. The application communication instructions generated by the application execution means 13 are, however, instructions that cannot be directly executed by the station contactless interface simulation means 15 and are therefore first to be converted with the aid of the data conversion means 14 into the Station Generic data SG, while these Station Generic data SG in a read/write station arranged for the contactless communication represent data for controlling the contactless interface of the read/write station.

In accordance with the Station Generic data SG, the station contactless interface simulation means 15 generate no analog data which occur with an actual communication, but digital data which form the Station Interface data SI. The Station Interface data SI then form a digital representation of the analog data generated by a contactless interface of a read/write station and are delivered to the transmission means 6 by the station connection means 16 via the data D.

The data D communicated thus to the data carrier simulation means 4 are received by the data carrier connection means 19 and delivered to the data carrier contactless interface simulation means 18 as Data Carrier Interface data DI, while the Data carrier Interface data DI form a digital representation of the analog data which can be received by a contactless interface of a data carrier. The Data carrier Interface data DI are received by the data carrier contactless interface simulation means 18 and delivered to the data carrier data processing simulation means 17 as data carrier application data DA. As a reaction to these Data carrier Application data DA, which in the present case include the application information data generated by the application execution means 13, a data processing is started in the data carrier data processing simulation means 17 in which processing also data D are to be communicated by the data carrier simulation means 4 to the station simulation means 2 if necessary.

When the communication of data D from the carrier simulation means 4, to the station simulation means 2 is simulated, the data carrier data processing simulation means 17 generate Data carrier Application data DA in reaction to the reception of application information and deliver them to the data carrier contactless interface simulation means 18. The Data carrier Application data DA are received by the data carrier contactless interface simulation means 18 while the data carrier contactless interface simulation means 18 simulate a behavior of a contactless interface of a data carrier arranged for contactless communication. Data carrier Interface data DI are generated then, which form a digital representation of analog data generated during a real communication between a data carrier and a read/write station. The Data carrier Interface data DI are delivered by the data carrier contactless interface simulation means 18 to the data carrier connection means 19 and communicated to the station simulation means 2 as data D.

In the station simulation means 2 these data D are converted into the Station Interface data SI by the station connection means 16, which Station Interface data SI in the present case form a digital representation of analog data occurring during such a real communication between a read/write station and a data carrier. The station contactless interface simulation means 15 receive the Station Interface data SI and generate Station Generic data SG according to the thus simulating contactless interface and deliver these data to the data conversion means 14. The data conversion means 14 receive the Station Generic data SG and generate the station application data SA in accordance with the Station Generic data SG which station application data SA are delivered to the application execution means 13 and which in the present case represent the Data carrier Application data DA generated in the course of the reaction of the data carrier processing simulation means 17 to the application information.

By providing the measures according to the invention, the advantage is obtained that the behavior of a read/write station and the behavior of a data carrier arranged for contactless communication with this read/write station can be simulated on a single computer with the aid of the system 1. Furthermore, the advantage is obtained that even the contactless communication between the simulated read/write station and the simulated data carrier can be simulated on a single computer with the aid of system 1.

It may be observed that on the single computer 11 it is also possible to arrange a plurality of data carrier simulation means 4, so that the advantage is offered that even on this single computer 11 a multipoint communication of the data D between the station simulation means 2 and the plurality of data carriers can be simulated with the aid of a corresponding number of data carrier simulation means 4.

1. A system for simulating a data communication between a read/write station and a portable data carrier, which system comprising means defined below, that is to say:
representation means representing a read/write station, and data carrier simulation means for simulating the behavior of the data carrier, and transmission means for transmitting data between the representation means and the data carrier simulation means, characterized in that the representation means are formed by station simulation means and in that the station simulation means are provided for simulating the behavior of a read/write station arranged for a contactless data communication and in that the data carrier simulation means are arranged for simulating the behavior of a data carrier arranged for contactless data communication.

2. A system as claimed in claim 1, characterized in that a plurality of data carrier simulation means are provided which are each arranged for simulating the behavior of a data carrier arranged for a contactless data communication.

3. A system as claimed in claim 2, characterized in that the plurality of data carrier simulation means are divided over various locations.

4. A system as claimed in claim 2, characterized in that a plurality of data carrier simulation means are divided over various locations relative to the location of the station simulation means.

5. A system as claimed in claim 1, characterized in that the transmission means are formed by means for realizing a data network.

6. A system as claimed in claim 5, characterized in that the data network is arranged for communication in accordance with an Interprocess Communication protocol.

7. A system as claimed in claim 6, characterized in that the data network is arranged for communication in accordance with the TCP/IP protocol.

8. A system as claimed in claim 1, characterized in that the station simulation means comprise station contactless interface simulation means which are arranged for simulating the behavior of the contactless interface of the station simulation means and in that the station simulation means comprise station connection means which are arranged for connecting the station contactless interface simulation means to the transmission means.

9. A system as claimed in claim 8, characterized in that the station connection means are arranged for connecting the station contactless interface simulation means to the transmission means in accordance with an Interprocess Communication protocol.

10. A system as claimed in claim 9, characterized in that the station connection means are arranged for connecting the station contactless interface simulation means to the transmission means in accordance with the TCP/IP protocol.

11. A system as claimed in claim 1, characterized in that the data carrier simulation means comprise data carrier contactless interface simulation means which are arranged for simulating the behavior of a contactless interface of the data carrier simulation means and in that the data carrier simulation means comprise data carrier connection means which are arranged for connecting the data carrier contactless interface simulation means to the transmission means.

12. A system as claimed in claim 11, characterized in that the data carrier connection means are arranged for connecting the data carrier contactless interface simulation means to the transmission means in accordance with an Interprocess Communication protocol.

13. A system as claimed in claim 12, characterized in that the data carrier connection means are arranged for connecting the data carrier contactless interface simulation means to the transmission means in accordance with the TCP/IP protocol.

14. A system part which is provided for simulating the behavior of a read/write station arranged for communication with a portable data carrier and which part includes representation means representing a read/write station, characterized in that the representation means are formed by station simulation means and in that the station simulation means are arranged for simulating the behavior of a read/write station arranged for a contactless data communication.

15. A system part as claimed in claim 14, characterized in that the station simulation means comprise station contactless interface simulation means which are arranged for simulating the behavior of the contactless interface of the station simulation means and in that the station simulation means comprise station connection means which are arranged for connecting the station contactless interface simulation means to transmission means.

16. A system part as claimed in claim 15, characterized in that the station connection means are arranged for connecting the station contactless interface simulation means to the transmission means in accordance with an Interprocess Communication protocol.

17. A system part as claimed in claim 16, characterized in that the station connection means are arranged for connecting the station contactless interface simulation means to the transmission means in accordance with the TCP/IP protocol.

18. A system part which is provided for simulating the behavior of a portable data carrier arranged for communication with a read/write station and which parts includes data carrier simulation means which are arranged for simulating the behavior of a data carrier, characterized in that the data carrier simulation means are arranged for simulating the behavior of a data carrier arranged for a contactless data communication.

19. A system part as claimed in claim 18, characterized in that the data carrier simulation means comprise data carrier contactless interface simulation means which are arranged for simulating the behavior of a contactless interface of the data carrier simulation means and in that the data carrier simulation means comprise data carrier connection means which are arranged for connecting the data carrier contactless interface simulation means to the transmission means.

20. A system part as claimed in claim 19, characterized in that the data carrier connection means are arranged for connecting the data carrier contactless interface simulation means to the transmission means in accordance with an Interprocess Communication protocol.

21. A system part as claimed in claim 20, characterized in that the data carrier connection means are arranged for connecting the data carrier contactless interface simulation means to the transmission means in accordance with the TCP/IP protocol.

22. A method of simulating a data communication between a read/write station and a portable data carrier, which method includes the following steps, that is:
activating transmission means provided for transmitting data between representation means and data carrier simulation means, in which the representation means represent the read/write station and the data carrier simulation means are provided for simulating the behavior of the data carrier, and communicating data with the aid of the activated transmission means between the representation means and the data carrier simulation means, characterized in that with the aid of station simulation means arranged as representation means the behavior of a read/write station arranged for the contactless data communication is simulated and in that with the aid of data carrier simulation means arranged for this the behavior of a data carrier arranged for a contactless data communication is simulated and in that a contactless communication of data between the station simulation means and the data carrier simulation means is simulated.

23. A method as claimed in claim 22 characterized in that with the aid of a plurality of data carrier simulation means arranged for this purpose the behavior of a plurality of data carriers arranged for contactless data communication is simulated and in that a contactless communication of data between the station simulation means and the plurality of data carrier simulation means arranged for contactless communication is simulated.

24. A method as claimed in claim 23, characterized in that a contactless communication of data between the station simulation means and the plurality of data carrier simulation means divided over various locations is simulated.

25. A method as claimed 23, characterized in that a contactless communication of data between the station means and the plurality of data carrier simulation means divided over various locations relative to the location of the station simulation means is simulated.
